(19) United States
(12) Patent Application Publication
(10) Pub. No.: US 2017/0061545 A1
(43) Pub. Date: Mar. 2, 2017

(54) SYSTEM FOR ANALYZING AND DISPLAYING OF INDIVIDUAL AND AGGREGATED DATA

(71) Applicant: Bethany Siddall, Fort Worth, TX (US)

(72) Inventor: Bethany Siddall, Fort Worth, TX (US)

(21) Appl. No.: 14/842,485

(22) Filed: Sep. 1, 2015

(51) Int. Cl. G06Q 40/08; G06F 3/0484; G06F 3/0481

(52) U.S. Cl. CPC G06Q 40/08; G06F 3/0481; G06F 3/0484

(57) ABSTRACT

Embodiments provide a system having a graphical user interface for analyzing and displaying of claims data in a centralized database, including: a database storing data related to vehicular damage; a processor; a memory, with the memory storing instructions executable by the processor to: access the data stored in the database to obtain information relating to automobile repair estimates of the damage; evaluate the information to identify at least one discrepancy between a first reference determined value and a second calculated value; generate a report of the at least one discrepancy; generate a score, based on the report, for the at least one discrepancy; determine if the discrepancy complies with reference data; and a display providing a graphical user interface that provides a display of individual and aggregated vehicular damage and repair data.

### BACKGROUND

One major concern regarding the estimation process is how subjective estimations can be. Estimate values tend to vary from one individual appraiser to another. Although estimation software and tools exist, there can still be a large variance between estimations.

If a vehicle is damaged and an insurance claim is made regarding the damage, the claim process begins. One of the most important parts of the claims process is the ability to estimate the dollar value require to repair the damage to the automobile (e.g., minor cosmetic repair, totaled, etc.). This process can be carried out by various individuals, but the result is generally the same. After the estimate is complete, the insurance company pays the estimated dollar value in order to facilitate the repair or replace the damaged property.

Thus, a simplified system is needed to review and record the large number of estimates and payouts an insurance company deals with in order to identify potential problems (e.g., fraud, faulty estimation methodology) and identify trends within the data.

### BRIEF SUMMARY

In summary, an embodiment provides a system having a graphical user interface for analyzing and displaying of claims data in a centralized database, comprising: a database storing data related to vehicular damage; a processor; a memory, with the memory storing instructions executable by the processor to: access the data stored in the database to obtain information relating to automobile repair estimates of the damage; evaluate the information to identify at least one discrepancy between a first reference determined value and a second calculated value; generate a report of the at least one discrepancy; generate a score, based on the report, for the at least one discrepancy; determine if the discrepancy complies with reference data; and a display providing a graphical user interface that provides a display of individual and aggregated vehicular damage and repair data.

An additional embodiment provides a system having a graphical user interface for analyzing and displaying of claims data in a centralized database, comprising: a database storing data related to vehicular damage; a processor; a memory, with the memory storing instructions executable by the processor to: access the data stored in the database to obtain information relating to automobile repair data; evaluate the information to identify at least one discrepancy between a first reference determined value and a second calculated value; generate a report of the at least one discrepancy; generate a score, based on the report, for the at least one discrepancy; determine if the discrepancy complies with reference data; and a display providing a graphical user interface that provides a display of individual and aggregated vehicular damage and repair; wherein the information relating to automobile repair data is user modifiable via the graphical user interface.

A further embodiment provides a computerized method for using a graphical user analyzing and displaying of claims data in a centralized database, comprising: obtaining, using a processor, information relating to automobile repair estimates; evaluating, using a processor, the information to identify at least one discrepancy between a first reference determined value and a second calculated value; generating, using a processor, a report of the at least one discrepancy; generating, using a processor, a score, based on the report, for the at least one discrepancy; determining, using a processor, if the discrepancy complies with a reference data; and displaying, on a display device, a graphical user interface that provides a display of individual and aggregated vehicular damage and repair data.

Additional embodiments are described, including other methods, as well as devices/apparatuses, systems including multiple devices, and products.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example distributed system.

FIG. 2 illustrates an example of selecting an estimate to review.

FIG. 3A illustrates an example form based on the estimate source being ASR.

FIG. 3B illustrates an example form based on the estimate source being CRSP.

FIG. 3C illustrates an example form based on the estimate source being a third party.

FIG. 4A illustrates an example GUI for exception entry selection.

FIG. 4B illustrates an example form for manual exception entry.

FIG. 4C illustrates an example form for exception entry using the exception calculator.

FIG. 5 illustrates an example reinspection summary form.

FIG. 6A illustrates an example reinspection result.

FIG. 6B illustrates an example of leakage percentage.

FIG. 7A illustrates an example graph of historical data.

FIG. 7B illustrates another example graph of historical data.

FIG. 7C illustrates another example graph of historical data.

FIG. 7D illustrates another example graph of historical data.

FIG. 8 illustrates an example system for utilizing a graphical user interface for reinspection and auditing of claims data.

FIG. 9 illustrates an example method of utilizing a graphical user interface for reinspection and auditing of claims data.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

An embodiment addresses the issues of large scale information review. As will become more apparent in the description of example embodiments, the discussed technological improvements offered by the various embodiments are applicable to a large variety of companies that use or maintain a large quantity of documentation that may require a review process and allow for evaluation of individual employees, contractors, or third party entities which perform services related to the company, e.g., Fortune 500 companies, across all vertical segments.

Although various example embodiments are described with a focus on insurance enterprise applications, e.g., insurance claims and estimates, the principles and technological improvements offered may likewise be applied to various applications, e.g., of transportation companies, manufacturing companies, insurance property claims, etc. Thus, embodiments permit enterprises, particularly large enterprises, to improve the reinspection and review process for various business activities (e.g., construction estimates, product valuations, etc.).

Throughout the specification, reference may be made to Customer Repair Service Programs (CRSP), which are third parties (e.g., auto body shops, repair stations, etc.) which are pre-approved by a particular insurance carrier to perform estimations for vehicle damage. Reference will also be made to Auto Service Representatives (ASR), which are typically direct employees of an insurance agency that visit the damaged property and conduct an estimation calculation for the policy holder's required repairs.

As discussed, typically once an insurance claim is made, an insurance adjuster, claims adjuster (e.g., ASR), or equivalent (e.g., a body shop certified as an approved estimator or CRSP) will determine the cost to repair or replace the damaged property. This process is carried out for every insurance claim and it is the basis for determining what the insurance company pays out to their policy holder to repair their property. Because this estimate drives the amount of money dispensed by the insurance company, great care is taken in its determination.

However, because the adjustment process is carried out by such a broad range of different individuals, it can be difficult to ensure proper consistency across the board. In order to identify outliers and discrepancies, a system is needed which can evaluate or reinspect a portion (e.g., 10%, 50%, 100%, etc.) of the previously entered adjustments. Thus, a reinspection system is needed that can streamline the process and maintain a historical list of all audited claims. This allows outliers to be identified over the long term or short term evaluation process. Outliers can exist for multiple reasons, (e.g., consistent over or under pricing based on an individual bias, intentional fraud, etc.) but whatever the reasons insurance companies need a customizable way to identify the outliers and address the issues.

In order to address all of the above discussed problems, an embodiment needs to improve the overall process discussed herein, enhance reinspection and allow for comparison of historical data. Thus, an embodiment provides a system that obtains information relating to automobile insurance repair estimates (e.g., ASR or CRSP estimates). The information is then processed to determine if a discrepancy exists within a single (or multiple) claim estimate. A report is then generated based on the identified discrepancy, which contains various details relating to the claim estimate. Based on the detailed information, a score is calculated in order to distill the report information to an easily comparable value for statistical analysis with other historical scores. Additionally, a user can manipulate the factors and process steps as required using a graphical user interface (GUI).

Embodiments represent a significant technical improvement to the reinspection process of insurance claims through an enhanced GUI implementation. An embodiment is directed to substantially more than merely a computer implementation of a routine or conventional activity previously known in the industry as it significantly advances the technical efficiency, access and/or accuracy of obtaining, processing, modifying, storing and comparing reinspected insurance claims by implementing a specific new method and system as defined herein.

An embodiment provides a specific advancement in the claims review for large companies (e.g., a large insurance company), by providing technical benefits for claim importation, claim evaluation, claim report generation, claim scoring, and statistical analysis of those evaluated claims and scores, such advances are not merely a longstanding commercial practice. The embodiments provide improvement beyond a mere generic computer implementation as they involve the processing and conversion of significant amounts of data in a new beneficial manner as well as the interaction of a variety of specialized insurance, client and/or vendor systems, networks and subsystems.

An embodiment may store all the information in a centralized system. Thus there is no need for multiple iterations of the data, and no way for confusion or of out date data to exist within the historical data. In addition, an embodiment manages each user's access level. Certain users will have greater access than others. This eliminates the possibility that a user could remove or modify data that they are not qualified or approved to modify. This reduces accidents and mistakes caused by user error.

The illustrated example embodiments will be best understood by reference to the figures. The following description is intended only by way of example, and simply illustrates certain example embodiments.

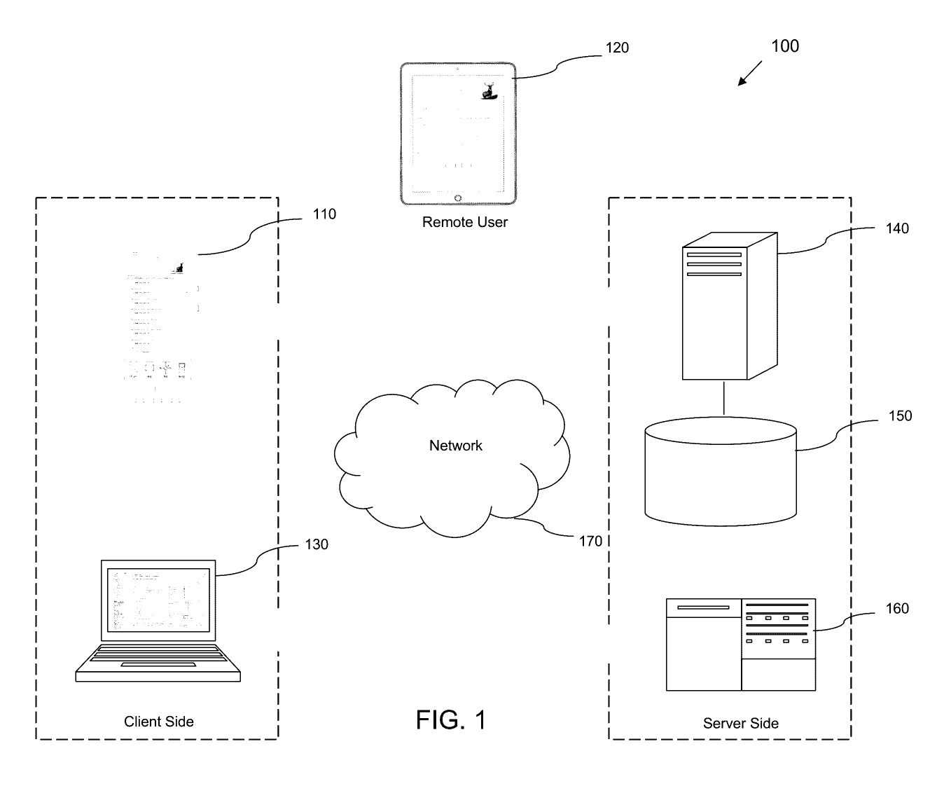

As illustrated in the non-limiting example of FIG. 1, in an embodiment, a distributed system 100 is provided such that the reinspection data may be entered into the system 100 by various devices, e.g., user mobile devices 110, user laptop or computing devices 130, and remote devices 120. The data may then be stored in a centralized server 140 utilizing in a database 150, or across a distributed server/cloud system 160. In addition to entering data into the system (e.g., exceptions, part prices, etc.), reporting may be made to various devices (e.g., updated price guides, graphic displays, textual summaries, etc.), either pushed to the devices and/or retrieved by various devices, (e.g., user mobile devices 110-130).

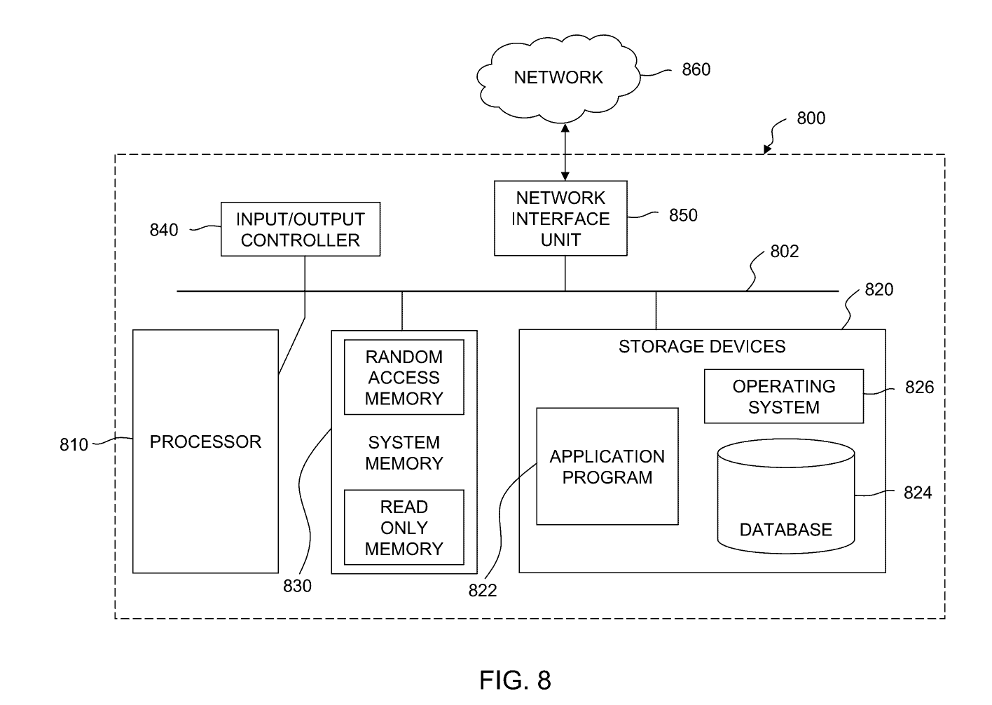

The database is connected to a network at 170 using a network connection device such as, for example, 850 of FIG. 8. The connection device may connect to a local area network (LAN) or a wide area network (WAN) at 170. This allows multiple end users 110-130, to access the reinspection database and conduct reinspection. By way of specific example, an end user 110-130 may operate his or her system to compile and send data relating to a plurality of parameters, e.g., exceptions, alternate parts details, document details, and total overage or leakage, etc. The end user systems 110-130 may send this data via a network, e.g., network 170, such that it is received by a database server, e.g., at 140. Database server 140, for its part, receives the data parameters sent by an end user system, e.g., 110-130, and processes the data parameters to identify specific exceptions and the like. The database server 140 then may manipulate the received data to calculate a final file score, as discussed herein. Additionally, the database server 140 may allow both local user 110 and remote user 120 to request previously calculated values and make subsequent adjustments to the data parameters.

Such data input into the distributed system 100, e.g., communication of data between user devices 110-130 (via network 170) to central device 140, may be automated or semi-automated. By way of example, if a user enters data into device 110 such entry may cause an application running on user device 110 to issue a communicating to device 140 updating the status of a reinspection. Likewise, device 140 may poll devices 110-130 for updates.

Similarly, device 140 (or a similar device acting as a coordinating or managing device) may process updates and distribute them to other devices (e.g., remote devices), again in an automated or semi-automated fashion. By way of example, an updated status determined by device 140 may be communicated to all devices in the distributed system 100 or a sub-set thereof. As a particular, non-limiting example, device 140 may update a reinspection case and identify one or more user devices associated with the updated status.

It should be noted that in addition to the updated task status, additional or alternative information may be provided. For example, data may be communicated by device 140 to devices 110-130 such that a graphic display may be rendered on the mobile devices. Likewise, underlying textual summaries further describing communication may be provided.

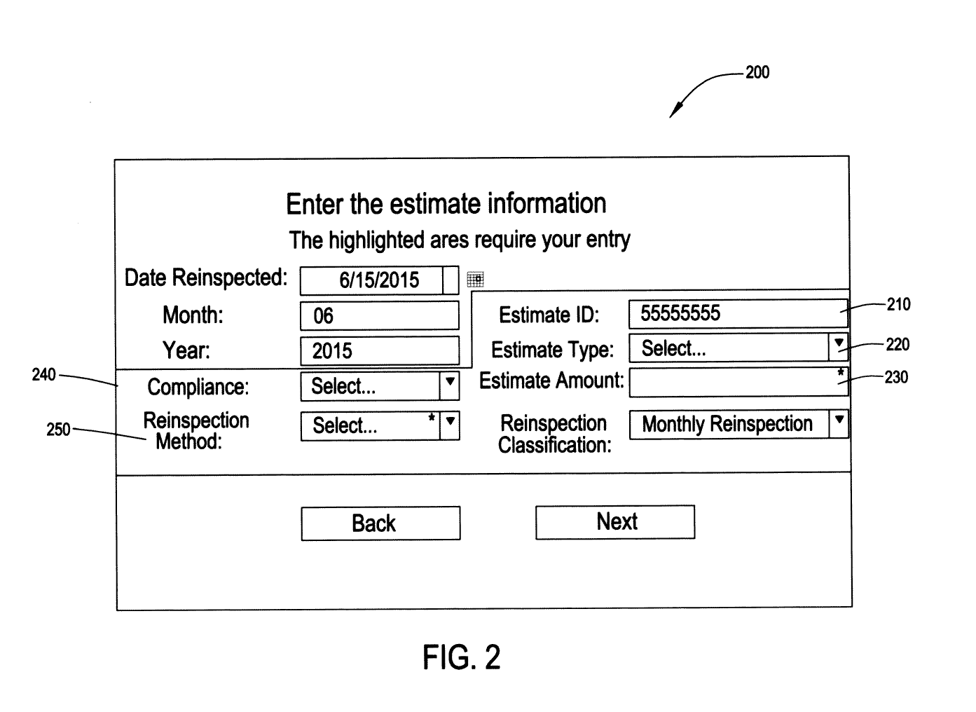

Referring to FIG. 2, an embodiment begins the reinspection process with the estimate information screen at 200. The various forms are filled out by the individual reviewing the claim estimate. In an embodiment, multiple individuals can access the review process from multiple teams. For example, an end user enters an estimate ID at 210. The estimate ID is a value assigned to particular claim estimates that have been completed by an ASR, CRSP, or like party.

The end user can then select the estimate type (e.g., a repairable vehicle, totaled vehicle, etc.) at 220. The estimate amount may be entered at 230, this is the total amount for the claim estimate. Compliance is a characteristic within the claim file itself that the end user can view (e.g., passed or failed a predetermined compliance evaluation). This information is then entered at 240.

In an embodiment, two types of reinspection can be completed, the first is a desk inspection which is done virtually by reviewing submitted or generated documents, the second is a field inspection which takes place onsite (e.g., where the damaged vehicle or property is located). The estimation method is selected at 250. In addition to allowing the end user to select each of the above values, the information can also be scrubbed or imported from the claim file data feed and auto populated. In a further embodiment, all or part of the data feed may be imported from a third party source.

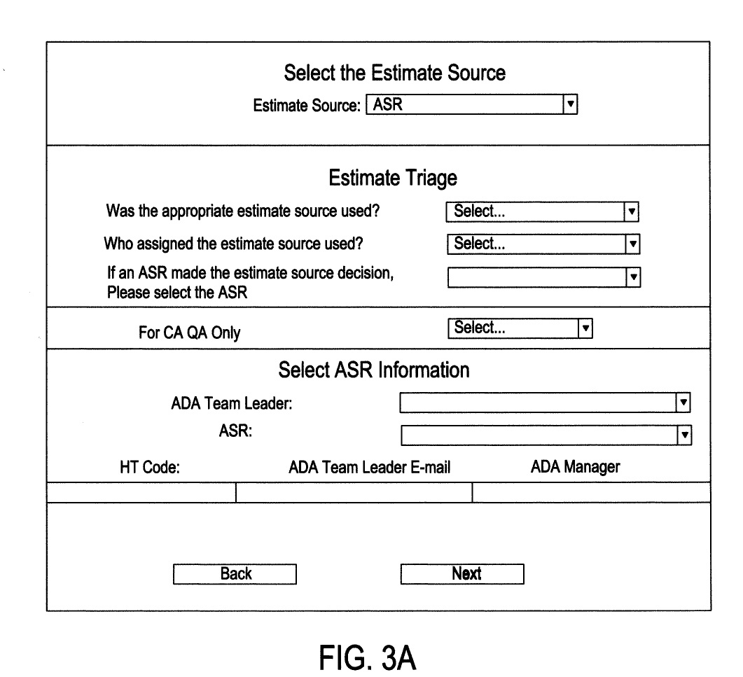

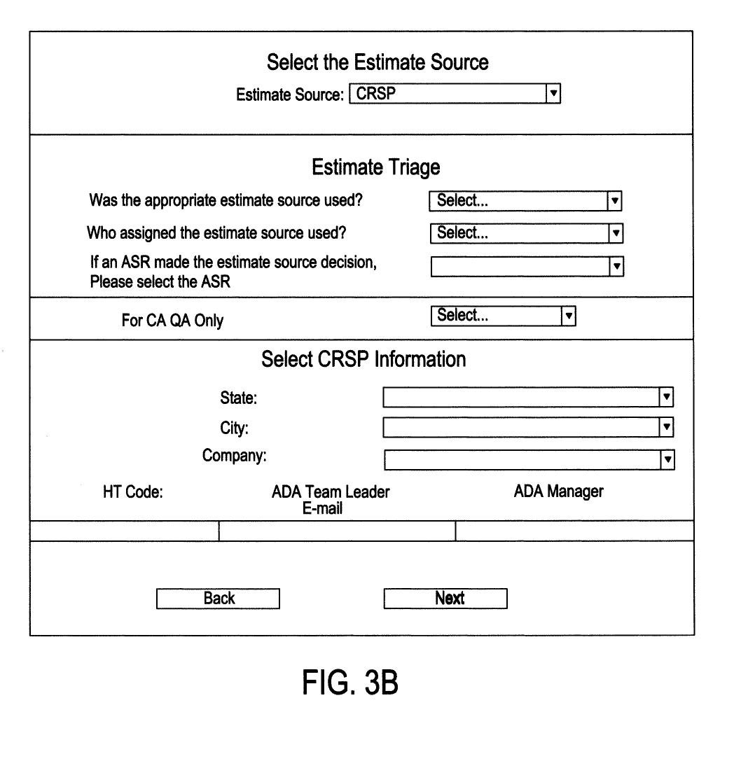

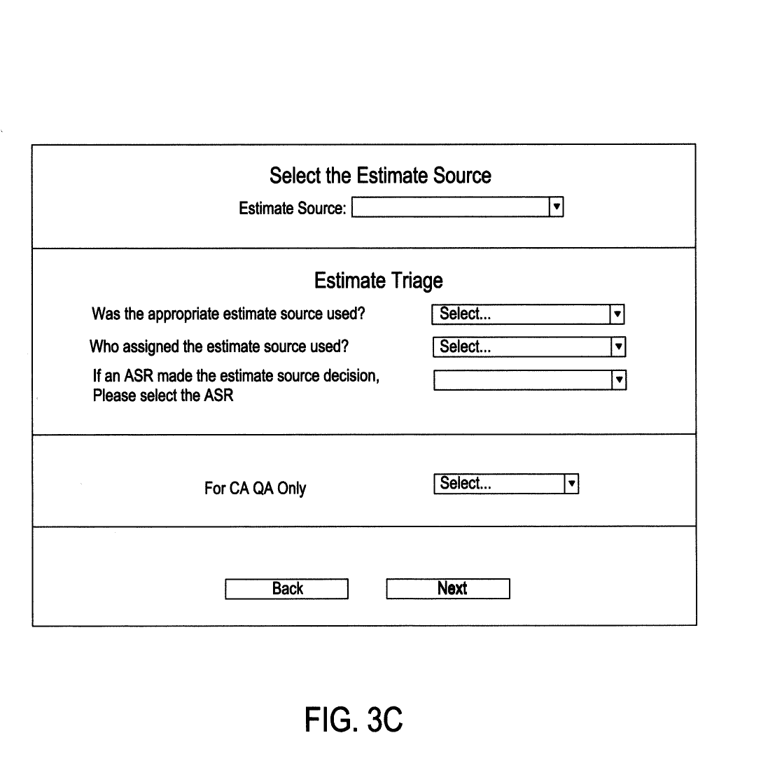

Based on the values populated or selected an embodiment can alter the following pages presented to the end user. For example, based on the estimate source selected, the form changes to allow input data related to the selected estimate source. In an embodiment, FIG. 3A shows a possible form layout selected based on the estimate source being an ASR. Thus, the user is prompted to enter the proper data, thereby reducing mistakes.

In an alternative embodiment, FIG. 3B shows a possible form layout based on the estimate source being a CSRP. Thus, the user is prompted to enter the proper data, thereby reducing mistakes. In another embodiment, FIG. 3C show a possible form layout if a third party estimating tool is selected. Thus, again the user is prompted to enter the proper data, thereby reducing mistakes.

Regarding FIGS. 3A, 3B, and 3C, embodiments allow for estimate triage information to be entered during the reinspection process. This allows the reinspection administrator to determine if the appropriate estimate source used by the appropriate entity (e.g., ASR, CRSP, etc.). For example, if a automobile was determined to be non-drivable, it may be determined that a CRSP would be in the best position to make that determination. Thus this information is gathered during the reinspection process to ensure the most effective procedures are in place.

Also shown in FIGS. 3A, 3B, and 3C is the “CA QA” drop down list. CA QA stands for California Quality Assessment. This is because certain jurisdictions, for example California, may request from an estimation source, any claims data for a determined range of time. (e.g., all claims data from the 2014 calendar year). Thus, this setting allows a user to more easily sort and identify a particular set of claims data that may relate to a particular jurisdiction. Although the figures and examples focused on the state of California, it should be obvious to one skilled in the art that the above disclosed steps can be used for any and all jurisdictions and jurisdiction types (e.g., states, countries, etc.).

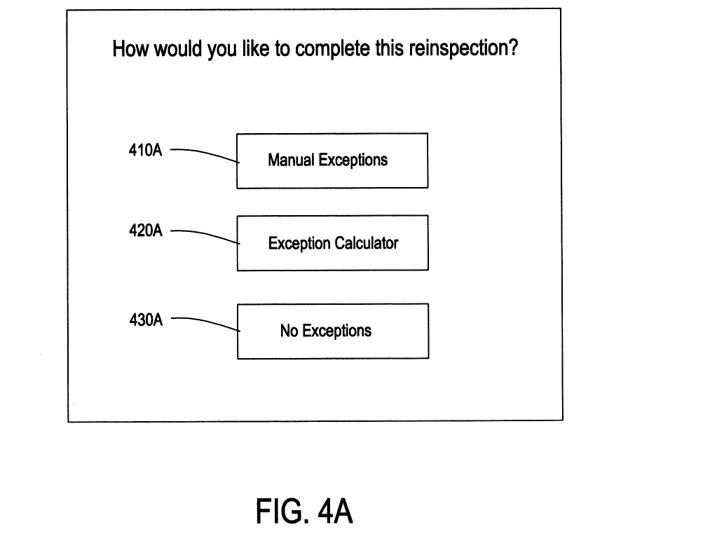

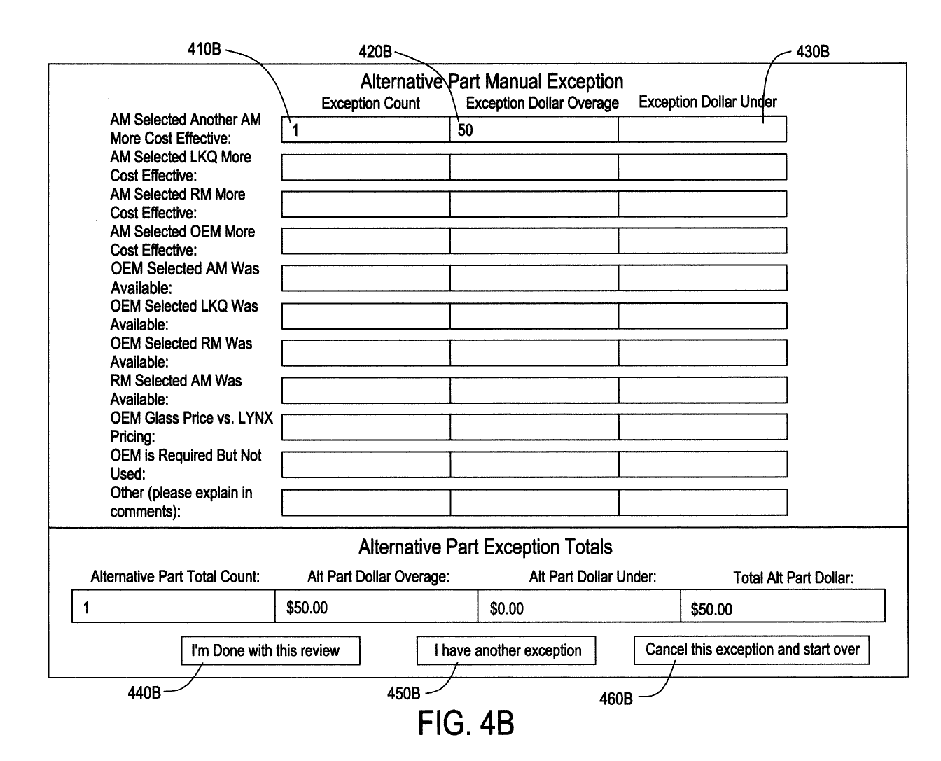

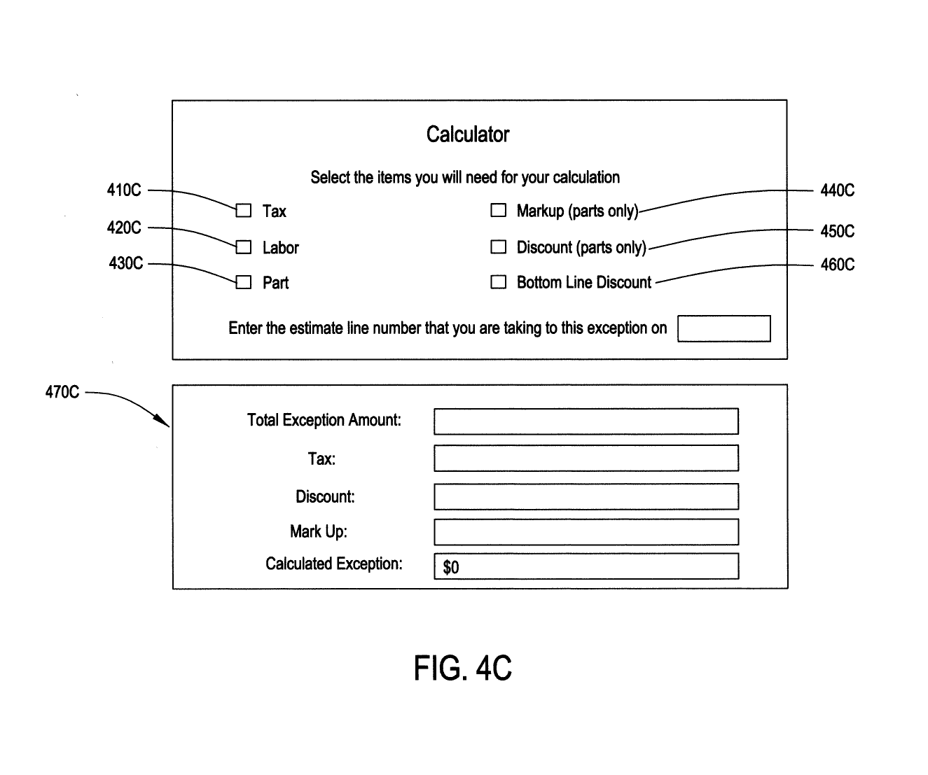

In a further embodiment, exceptions can be taken into account during the reinspection process. An end user can use their professional judgement to grant exceptions during the review process, generally these exceptions can be determined in one of two ways, the manual exception form or using the exception calculator. For example, an embodiment may display multiple methods of granting an exception such as that shown in FIG. 4A. In one embodiment, a user may wish to enter the exceptions manually by clicking the “Manual Exceptions” button at 410A. In additionally or alternatively, an embodiment may allow an end user to choose the “Exception Calculator” at 420A as the entry method. It is also possible that no exceptions are included in the reinspection tool, by for example, by selecting the “No Exceptions” option at 430A.

In an embodiment, exceptions may be categories within a particular estimate that allows for potential opportunities to be grouped together and reported upon. Additionally, each exception category may have sub-categories, which can provide a more detailed view into the estimate opportunity. Moreover, these exception categories may be used in order to track and report opportunities by each estimate source. In a further embodiment, the total number of exceptions as well as the dollar value associated with the exceptions may be used to determine the final score of the review.

If the “Manual Exception” option is selected at 410A, an embodiment displays on the GUI the “Alternative Part Manual Exception” form shown in FIG. 4B. This allows an end user to manually enter the data they deem worthy of an exception from the claims file. For example, if there is a documentation exception the end user desires to take (e.g., the labor rate on the estimate is incorrect, a price change for a part, an incorrect price quoted for a part, etc.) the end user may calculate the total number of times a particular error exists and enter it in the “Exception Count” column at 410B. The end user then enters the dollar value in the “Exception Dollar Overage” column at 420B if the exception is based on an over estimation error. Alternatively, the end user could enter the dollar value in the “Exception Dollar Under” column at 430B if the exception is based on an under estimation error.

In another embodiment, once the end user has entered the desired counts and dollar values, they may choose from three options. The first of which is to complete the review and move on to the summary page by selecting “I'm done with this review” at 440B. Alternatively, the user can select the “I have another exception” option at 450B which returns them to the GUI display shown in FIG. 4A and allows for an additional selection of an exception type. Finally, the user may choose the “Cancel this exception and start over” at 460B option if they wish to cancel their current entry and again revert back to the GUI display shown in FIG. 4A.

If the Exception Calculator option is selected at 420A, an embodiment displays the “Calculator” form shown in FIG. 4C on the GUI. This allows an end user to select the items they wish to include in their calculation (e.g., Tax at 410C, Labor at 420C, Part at 430C, Markup at 440C, Discount at 450C, Bottom Line Discount at 460C, etc.). Based on which selections the user makes, a corresponding form is created. For example, in an embodiment, if a user selected Tax, Discount, and Mark Up the form shown at 470C would be created to allow the user to enter the desired exception.

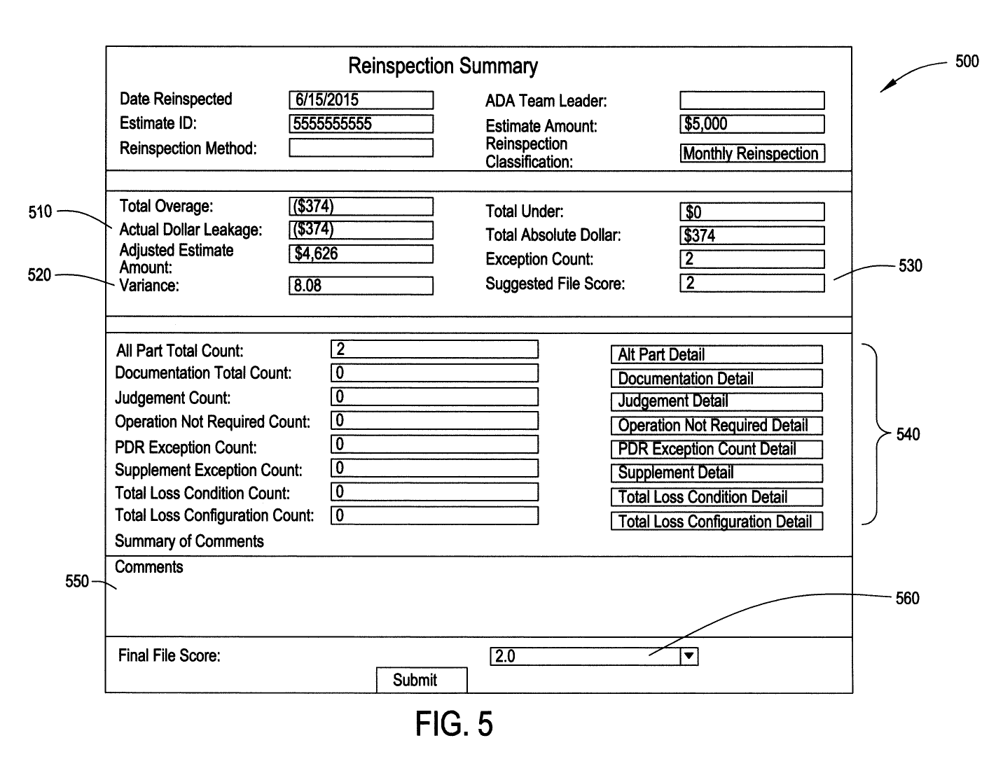

Now referencing FIG. 5, an embodiment may, once the user has entered all of the desired exceptions via the GUIs at FIGS. 4B and 4C, or entered no exceptions via the “No Exceptions” button at 430A the “Reinspection Summary” GUI is displayed at 500. The Reinspection Summary form shows a broad overview of the total reinspection process. Including the previously entered values discussed above (e.g., Estimate ID, Estimate Type, Estimate Amount, Total Overage/Under, etc.). Based on all of the data collected during the reinspection process (e.g., the information manually entered by the user or scrubbed and imported from the claim file data feed) an “Actual Dollar Leakage” is determined at 510. This actual dollar leakage is equivalent to the total dollar loss due to the incorrect estimate. For example, if an ASR overestimated the cost to replace a specific car part (e.g., fender) the total amount of over payment is equal to the leakage.

The very nature of an estimate is that it is a guess on what the total cost should end up being. Therefore, it is generally accepted that some leakage will always occur with respect to the estimation process. Thus, a method is needed to identify outliers or cases of extreme leakage. In order to accomplish this, an embodiment relies on a company or industry specific algorithm to determine a total variance percentage at 520. Through the use of the variance calculation, it is possible to identify outliers in the estimation process.

In a further embodiment, a suggested file score is calculated and displayed at 530 based on the variance percentage at 520. The determination of this suggested file score can be modified to be company or department specific. This allows for multiple embodiments and grants the ability to compare and contrast a range of reinspected items. Additionally, an embodiment may adjust the algorithm to weight particular reinspected items more heavily. For example, if an estimate of an automobile claim is being reinspected, the tolerance for error in strict dollar amounts is likely to be smaller than for something much larger (e.g., a home). The ability to weight the automobile claim variance at a greater value may allow for estimators (e.g., ASRs) to be evaluated across a spectrum of claim types.

An embodiment may allow a user to review the exception detail and make additional modifications at 540. Each selection shown at 540 allows an end user to revisit (e.g., go back to the associated dialog screen) each specific exception detail within the reinspection form. This enhances the user experience by allowing for an easily managed and implemented method for modifying, creating, or removing additional exceptions if required. Additionally, a user can include comments regarding the reinspection process (e.g., explaining the included exceptions and any professional judgement calls that where made) at 550. Finally, an embodiment allows for the “Final File Score” to be adjusted at 560. The final file score is extremely important, because it acts as a determining factor when comparing a group of reinspected claim estimates in a statistical manner.

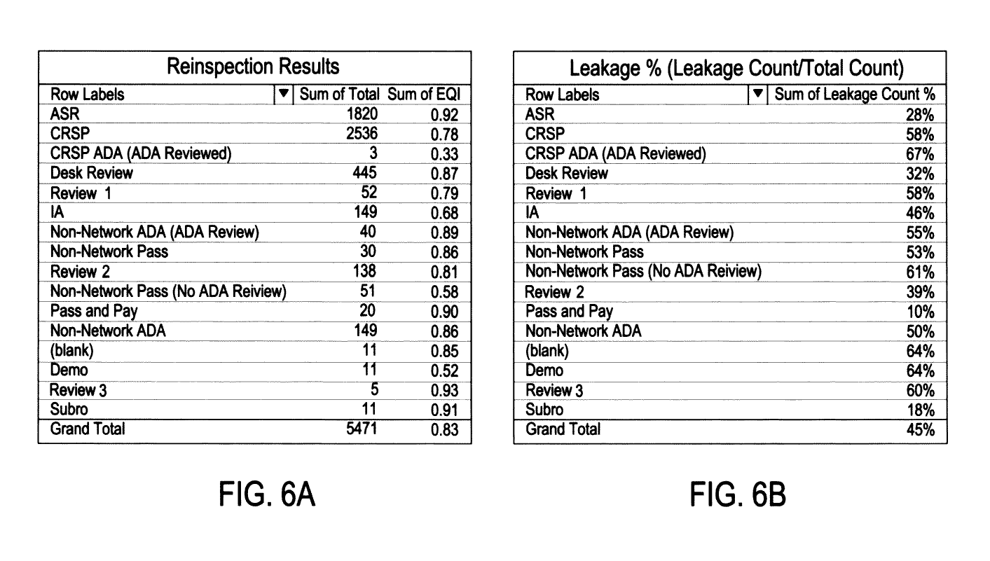

Referring now to FIGS. 6A and 6B, once the report is generated and a final score assigned, the system can perform a statistical analysis on the total claim inspection. The statistical analysis allows for the calculation of a baseline. For example, FIG. 6B shows a “Sum Leakage Count %” for various methods of estimation (e.g., ASR, CRSP, etc.). This level of data detail is unavailable in current reinspection tools. Thus an embodiment's proposed solution allows for the collection and display of previously unknown or unrecorded information. In an embodiment, this baseline calculation is used in the aforementioned variance calculation algorithm.

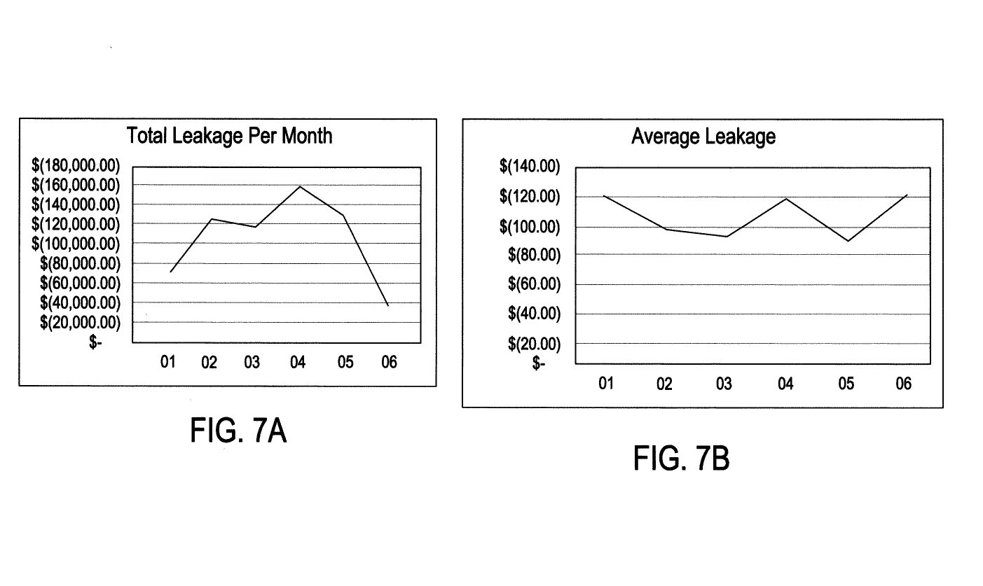

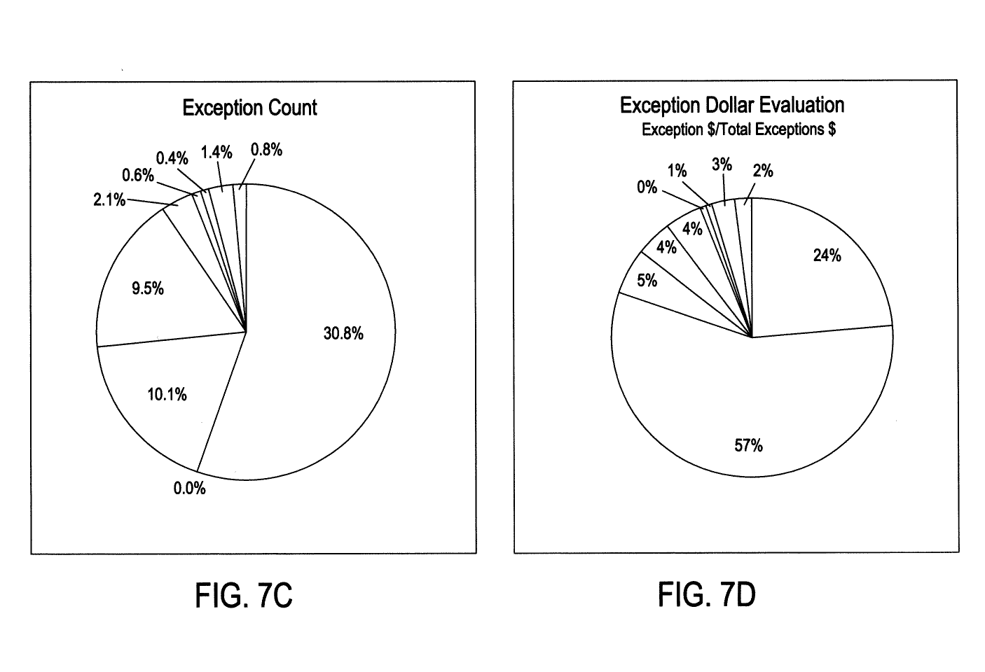

Based on the report and collected information, an embodiment, compares the current data against historical data to identify outliers and current trends. For example, FIG. 7A displays the trend of “Total Leakage Per Month,” this allows a user to view a large quantity of data in a format that is easier to digest and analyze. An additional embodiment may display the average leakage across an entire company, industry, or department such as that shown in FIG. 7B. Additional examples of visual representations of historical data are shown in FIGS. 7C and 7D.

The graphical user interface for reinspection of claim estimation may be implemented in an automated or semi automated system using appropriate circuitry and components programmed according to the various embodiments. While various other circuits, circuitry or components may be utilized in computing devices utilized for such special purposes, an example illustrated in FIG. 8 includes a system design found for example in laptop, desktop or other computing platforms. Such circuitry 800 may be used in a device that obtains claim data for a reinspection process, as described herein, such as a computing device of an insurance carrier used for the evaluation process.

In the example of FIG. 8, a storage device 820 includes software such as an enterprise application portfolio management application program 822 that may be run or executed by processor(s) 810 according to an operating system 826. The circuitry 800 provides that the processor loads the operating system 826 and thereafter the application program 822, e.g., into memory 830.

System 800 typically includes a network interface 850 facilitating communications with other devices, e.g., a connection to other devices over a network 860 using components such as a WWAN transceiver, a WLAN transceiver or a wired connection, e.g., a LAN connection. Commonly, system 800 will include an input/output controller 840 for data input and display. System 800 typically includes various memory 830 and storage devices 820, for example a database 824, e.g., for storing modules and gap data, referred to herein.

Device circuitry, as for example outlined in FIG. 8, may be used by insurance carriers for reinspection and tracking of claims and their respective estimates in a centralized database. It will also be apparent that circuitry other than the non-limiting example outlined in FIG. 8 may be used.

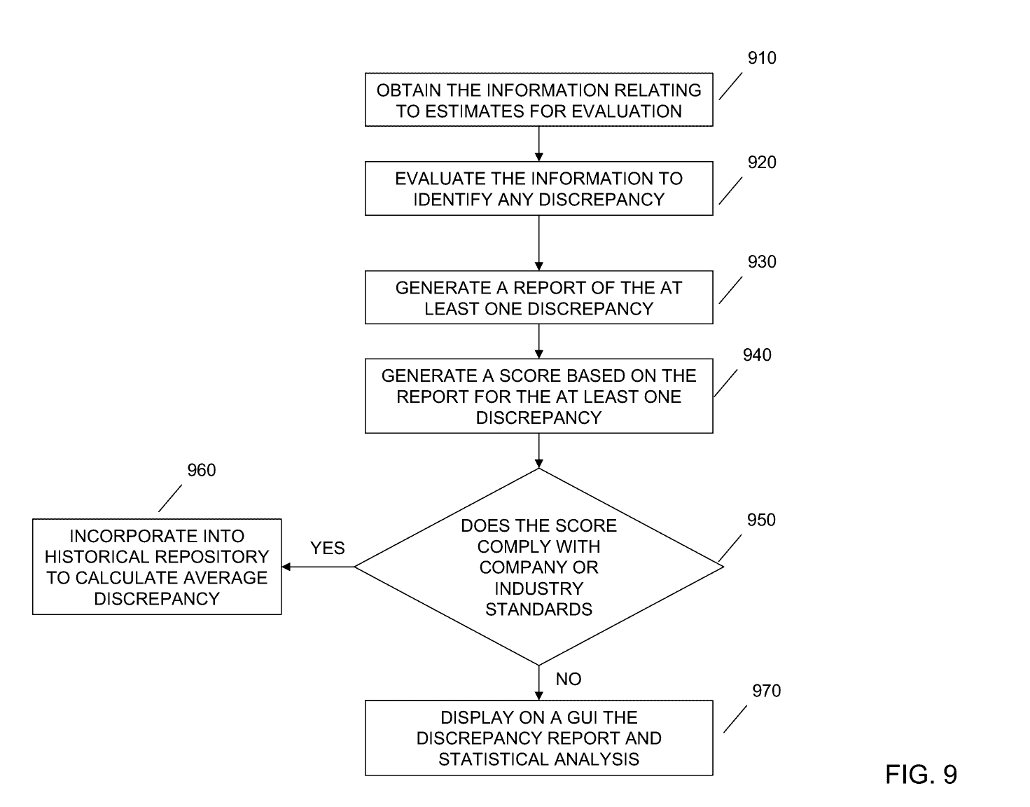

By way of example, FIG. 9 illustrates an example method of a graphical user interface for reinspection and auditing of claims data in a centralized database. In an embodiment, information relating to at least one estimate is obtained for evaluation at 910. This information can be obtained through a variety of methods. For example, an embodiment may extract the information from a data feed generated by a third party application utilized by a CRSP (e.g., the estimation software used in automobile repair shops and passed to insurance carriers). Alternatively, the information can be user entered or information that is stored in a database. The database can be owed by a third party, stored in within the same system as the reinspection application, or any scenario in between.

Once the information is obtained, an embodiment evaluates the information to identify any discrepancies at 920 (e.g., under estimates on parts, over estimates on labor, etc.). The discrepancies are evaluated during the reinspection process based on exceptions. The exceptions are values that can be obtained though various means as discussed herein. Once all exceptions have been entered, an embodiment allows the user to verify that all of the entries are correct and them adjust accordingly if they are not

Once the verification process has taken place, a report is generated at 930 based on the at least one discrepancy and the determined exceptions. As discussed herein, an embodiment may generate the report using a various methods (e.g., manual exception entry and a software exception calculator). As shown in FIG. 5, the report is user modifiable via a graphical user interface. Once each value is determined to be correct by the end user, and any adjustments are made, a score is generated based on the report for the at least one discrepancy at 940. In a further embodiment, the score is based on a variance percentage that is calculated using historical data relating to the estimation process. The historical data used in this process can be company specific, or obtained from a third party and incorporate a geographic region or specific industry.

In an embodiment, the calculation of the score and the variance percentage can be modified as required by an individual company or industry. The score is generated using an algorithm and as discussed herein, the algorithm may allow for a weighting of claims in order to evaluate estimations across a broad spectrum. For example, an ASR's estimation variance may be weighted heavier on lower cost items (e.g., older cars, cheaper cars, etc.) and weighted lower on more expensive items (e.g., luxury cars, homes, boats, etc.). As the cost of property goes up, the cost of repairs likely also go up, thus increasing the amount of leakage possible (i.e., as costs rise, errors in those costs also rise).

Once the all the discrepancies are calculated, the score, report, and discrepancy are compared against the aforementioned historical data to determine if the claim estimate is inline with industry standards (i.e., is the leakage greater than the determined average) at 950. If the data indicates that the score complies with industry standards, it is stored in a historical repository at 960 and used in later evaluations of future reinspections.

Alternatively, if it is determined that the score, report, and discrepancy do not comply with industry standards at 950, an embodiment may display a visual indicator of the comparisons made (e.g., a graph or table showing the accepted standard versus the current calculated leakage) at 970.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device(s) may be utilized. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A system having a graphical user interface for analyzing and displaying of claims data in a centralized database, comprising:
a database storing data related to vehicular damage;
a processor;
a memory, with the memory storing instructions executable by the processor to:
access the data stored in the database to obtain information relating to automobile repair estimates of the damage;
evaluate the information to identify at least one discrepancy between a first reference determined value and a second calculated value;
generate a report of the at least one discrepancy;
generate a score, based on the report, for the at least one discrepancy;
determine if the discrepancy complies with reference data; and
a display providing a graphical user interface that provides a display of individual and aggregated vehicular damage and repair data.

2. The system of claim 1, wherein the information relating to automobile repair estimates is user modifiable via a graphical user interface.

3. The system of claim 1, wherein the information relating to automobile repair estimates is obtained from a third party software application.

4. The system of claim 1, wherein the generation of the score is based on an algorithm, the algorithm being user modifiable via a graphical user interface.

5. The system of claim 1, wherein the discrepancy is determined based on at least one exception.

6. The system of claim 5, wherein the discrepancy is calculated using a calculation method selected from the group consisting of: manual exception entry and software exception calculator.

7. The system of claim 1, wherein the generating a score further comprises: generating a score based off of a variance percentage.

8. A system having a graphical user interface for analyzing and displaying of claims data in a centralized database, comprising:
a database storing data related to vehicular damage;
a processor;
a memory, with the memory storing instructions executable by the processor to:
access the data stored in the database to obtain information relating to automobile repair data;
evaluate the information to identify at least one discrepancy between a first reference determined value and a second calculated value;
generate a report of the at least one discrepancy;
generate a score, based on the report, for the at least one discrepancy;
determine if the discrepancy complies with reference data; and
a display providing a graphical user interface that provides a display of individual and aggregated vehicular damage and repair;
wherein the information relating to automobile repair data is user modifiable via the graphical user interface.

9. The system of claim 8, wherein the information relating to automobile repair data is obtained from a third party software application.

10. The system of claim 8, wherein the generation of the score is based on an algorithm, the algorithm being user modifiable via a graphical user interface.

11. The system of claim 8, wherein the discrepancy is determined based on at least one exception.

12. The system of claim 11, wherein the discrepancy is calculated using a calculation method selected from the group consisting of: manual exception entry and software exception calculator.

13. The system of claim 8, wherein the generating a score further comprises: generating a score based off of a variance percentage.

14. A computerized method for using a graphical user analyzing and displaying of claims data in a centralized database, comprising:
obtaining, using a processor, information relating to automobile repair estimates;
evaluating, using a processor, the information to identify at least one discrepancy between a first reference determined value and a second calculated value;
generating, using a processor, a report of the at least one discrepancy;
generating, using a processor, a score, based on the report, for the at least one discrepancy;
determining, using a processor, if the discrepancy complies with a reference data; and
displaying, on a display device, a graphical user interface that provides a display of individual and aggregated vehicular damage and repair data.

15. The method of claim 14, wherein the information relating to automobile repair estimates is user modifiable via a graphical user interface.

16. The method of claim 14, wherein the information relating to automobile repair estimates is obtained from a third party software application.

17. The method of claim 14, wherein the generation of the score is based on an algorithm, the algorithm being user modifiable via a graphical user interface.

18. The method of claim 14, wherein the discrepancy is determined based on at least one exception.

19. The method of claim 18, wherein the discrepancy is calculated using a calculation method selected from the group consisting of: manual exception entry and software exception calculator.

20. The method of claim 14, wherein the generating a score further comprises: generating a score based off of a variance percentage.
